(19) United States
(12) Patent Application Publication
(10) Pub. No.: US 2014/0090261 A1
(43) Pub. Date: Apr. 3, 2014

(54) COMBINATION TOOL

(71) Applicant: Nelson Travis Jones, Blairsville, GA (US)

(72) Inventor: Nelson Travis Jones, Blairsville, GA (US)

(21) Appl. No.: 13/632,156

(22) Filed: Sep. 30, 2012

(51) Int. Cl. G01B 3/56

(52) U.S. Cl. 33/418

(57) ABSTRACT

An adjustable carpenter square for measuring and marking a work product is provided. The adjustable carpenter square includes a solid body frame, solid body frame base attached to solid body frame, an angle gauging arm pivotally attached to solid body frame, a base rod, a one or more spacing fingers pivotally connected at the base rod and thus allows pivotal movement of the spacing fingers and resting on the solid body frame. The adjustable carpenter square performs multiple functions such as squaring, gauging, gapping, and angle measurement.

### BACKGROUND OF THE INVENTION

The invention generally relates to a combination tool, and more particularly relates to an adjustable carpenter's tool for squaring, gapping, gauging and angle determination.

Various multi-purpose combination tools are known in the art that help a carpenter in field of construction. These tools help the carpenter either in the field of squaring, gauging, gapping, or angle determination. Some of these multi-purpose tools combine the features of a traditional framing square along with tri, miter and protractor squares. Also, various large saw guides are used for cutting straight lines over large distances. Further, these devices are difficult to carry along.

For example, U.S. Pat. No. 4,503,624 to Whiteford discloses a combination square, scribing square and plumb level which is basically a carpenter's square in which an elongate blade is connected perpendicularly to an elongate handle. The blade has measuring scales on opposite edges, each of which commence at the adjacent edge of the handle, and lines which extend across the blade to permit easy visual alignment of both scales. Elongate apertures are formed along each line to facilitate use of the square as a scribing tool. The handle is a clear plastic hollow shell which is substantially filled with a liquid except for a small bubble so that the handle can function as a plumb level.

However, the Whiteford '624 patent fails to provide an easy to access, time-saving solution for the on-the-job needs found in construction.

Therefore there is a need for a carpenter's square to perform squaring, gauging, gapping, and angle determination and further which is convenient to carry in a pocket of a carpenter.

Further, there is a need for a carpenter's square which can be adjusted to allow measurement from any angle.

Furthermore, there is a need for a multi-purpose carpenter's tool capable of measuring gaps between work products, e.g. pavers.

### BRIEF SUMMARY OF THE INVENTION

In accordance with the teachings of present invention, an adjustable carpenter tool to carryout squaring, gauging, gapping, and angle instrument, is provided.

The adjustable carpenter tool has the following elements:
a solid body frame
a solid body frame base
leveling bubbles
hands free leveling
degree markings
angle gauging arm
spacing fingers
base rod for spacing fingers

The Solid Body Frame (SBF) is a solid metal piece which consists of five component elements. The outside dimensions are 3½ inches by 6 inches. Three sides of the SBF are marked in ⅛ inch increments. Numbers are shown in one inch increments.

The Solid Body Frame Base (SBFB) is disposed on one end of the SBF and is ⅜ inches thick. It protrudes ¾ inches on one side and ¼ inch on the opposite side. This allows a user to obtain measurements from varied positions and on various types of materials. The ¾ inch lip can be used to measure angles when working with materials which have a rough or rounded edge. The ¼ inch lip is best for working with materials which have smaller dimensions or depth.

The Leveling Bubble (LB: there are two level bubbles in the Solid Body Frame. One is positioned in the left side and another one is in the top of the frame. The purpose of these leveling bubbles is to assure a level state with any materials being used. The inclusion of the LB helps to provide a useful convenience to the craftsman without having to reach for another tool. The LB is only one of several components which allows this tool to replace other popular items from a typical tool bag.

Hands Free Leveling: there are two openings in the SBF which accommodate the need to suspend the tool when needed. One of these openings is on each side of the level bubble which is inside the long side of the SBF. These openings lend themselves to being temporarily supported by a screw or nail.

Degree Markings (DM): these angle markings are located beneath the level bubble along the long dimension of the tool. These markings permit a user to determine the angle of material intersections and/or to place a mark on materials when required angles have been provided.

Angle Gauging Arm (AGA): the angle gauging arm is 6 inches in length and it is stored in a triangular manner on the front of the tool. This pivoting arm is attached on one end by a screw and wing nut while it slides into a small opening on the other end. When the wing nut is loosened and the AGA is removed from this opening, the arm is free to swing as needed to assist the measurement of any angle. This AGA is marked in ⅛ inch increments and is numbered 1 inch increments. This Angle Gauging Arm is an important and unique feature of this tool.

The AGA provides many different solutions for measurements even when working with materials or objects which have multiple angles on one surface or cut. It is ⅛ inch thick and ⅜ inch wide and can also be used to mark circular designs. A user can unscrew the wing nut and the AGA becomes a straight edge. It is also useful for gauging depths, widths and spacing.

Spacing Fingers (SF): the fingers provide the central focal point for this entire tool concept. There are 37 fingers and each is ⅛ inch wide and 2⅝ long. Each one has a slotted end which allows the Spacing Fingers to rest on the lip within the Solid Body Frame. This inset allows the Spacing Fingers to remain flush with the frame. Each Spacing Finger is hinged from a rod which runs the full length of the Solid Body Frame on the inside.

The purpose of the SF is to gauge the gap or spacing within any working material. Measurements no longer need to be determined by numerical fractions but instead gaps and spacing can be accurately identified by the number of Spacing Fingers required to fill the space. The Spacing Fingers used to determine measurements are also used to actually make the marks for cuts and fittings. In practice, there are many useful roles for this innovative tool.

Base Rod for Spacing Fingers: this rod extends the full length of the inside leg of the Solid Body Frame and it provides pilotable movement for the Spacing Fingers. The rod is threaded on both ends to receive a retainer screw which serves to secure all spacing fingers. These retainer screws provide user with easy friction control and they accommodate easy clean up and maintenance if needed.

The width of this tool is dimensioned to be exactly 3½ inches (the size of a finished 2×4) which is a material size most common to many projects.

The driving force behind the creation of this unique tool was to deliver a small hand tool which could provide easy accuracy while eliminating non-productive time in a wide variety of construction projects.

An aspect of the technology described herein is to provide an adjustable carpenter tool with a solid body frame, angle gauging arm and spacing fingers to gauge gaps within a work product or between work products.

An aspect of the technology described herein is to provide an adjustable carpenter tool with leveling bubbles within a hands-free leveling unit.

Another aspect of the technology described herein is to provide an adjustable carpenter tool with thirty-seven spacing fingers.

Another aspect of the technology described herein is to provide an adjustable carpenter tool which may be conveniently carried in a pocket of a carpenter.

### BRIEF DESCRIPTION OF THE SEVERAL VIEWS OF THE DRAWING

FIG. 1 illustrates a perspective view of an adjustable carpenter tool, in accordance with a preferred embodiment of the technology described herein;

FIG. 2 illustrates an exploded view of the adjustable carpenter tool, in accordance with a preferred embodiment of the technology described herein;

FIG. 3 illustrates another perspective view of the adjustable carpenter tool, in accordance with a preferred embodiment of the technology described herein;

FIG. 4 illustrates a top view of the adjustable carpenter tool, in accordance with a preferred embodiment of the technology described herein;

FIG. 5 illustrates a side view of the adjustable carpenter tool, in accordance with a preferred embodiment of the technology described herein; and

FIG. 6 illustrates a front view of the adjustable carpenter tool, in accordance with a preferred embodiment of the technology described herein.

### DETAILED DESCRIPTION OF THE INVENTION

While this invention is illustrated and described in a preferred embodiment, the adjustable carpenter square may be produced in many different configurations, forms and materials. There is depicted in the drawings, and will herein be described in detail, as a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the technology described herein.

Reference will now be made in detail to several embodiments of the invention which are illustrated in the accompanying drawings. Wherever feasible and convenient, the same reference numerals are used in the figures and the description to refer to the same or like parts. The drawings are in a simplified form and not to precise scale. For purposes of convenience and clarity only, directional terms, such as top, bottom, left, right, up, down, over, above, below, beneath, rear, and front may be used with respect to the accompanying drawings. These and similar directional terms should not be strictly construed to limit the scope of the invention. In addition, words such as attached, affixed, coupled, connected and similar terms with their inflectional morphemes are used interchangeably, unless the difference is noted or made otherwise clear from the context. These words and expressions do not necessarily signify direct connections, but include connections through mediate components and devices.

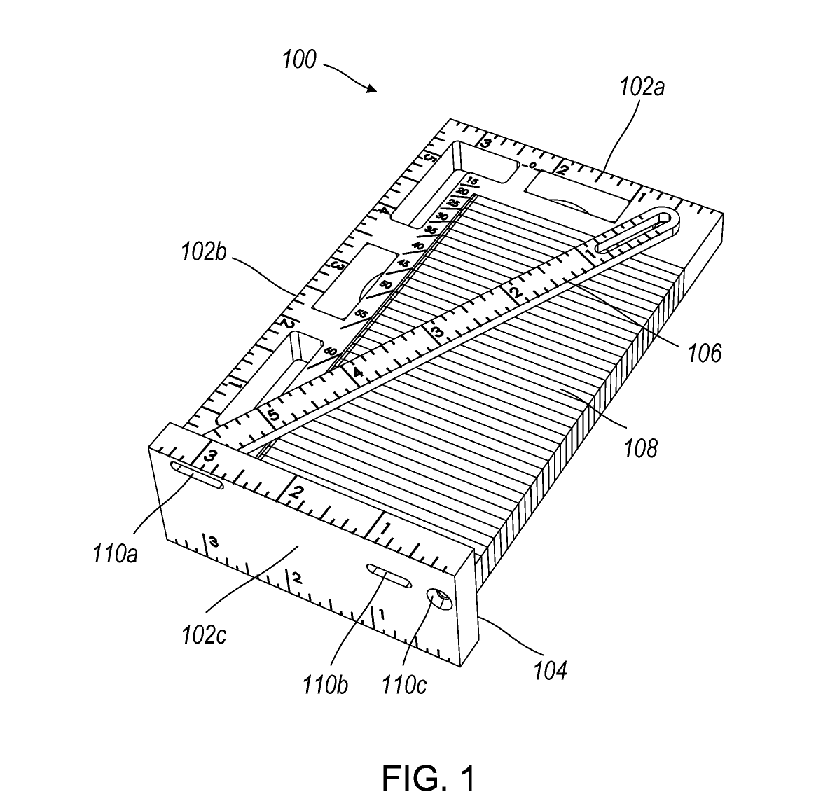

FIG. 1 illustrates a perspective view of an adjustable carpenter square 100. The adjustable carpenter square 100 to be used by a carpenter/user on a work product. The adjustable carpenter square 100 includes a solid body frame 102, a solid body frame base 104, an angle gauging arm 106, a one or more speed fingers 108 and a base rod (not shown in FIG. 1).

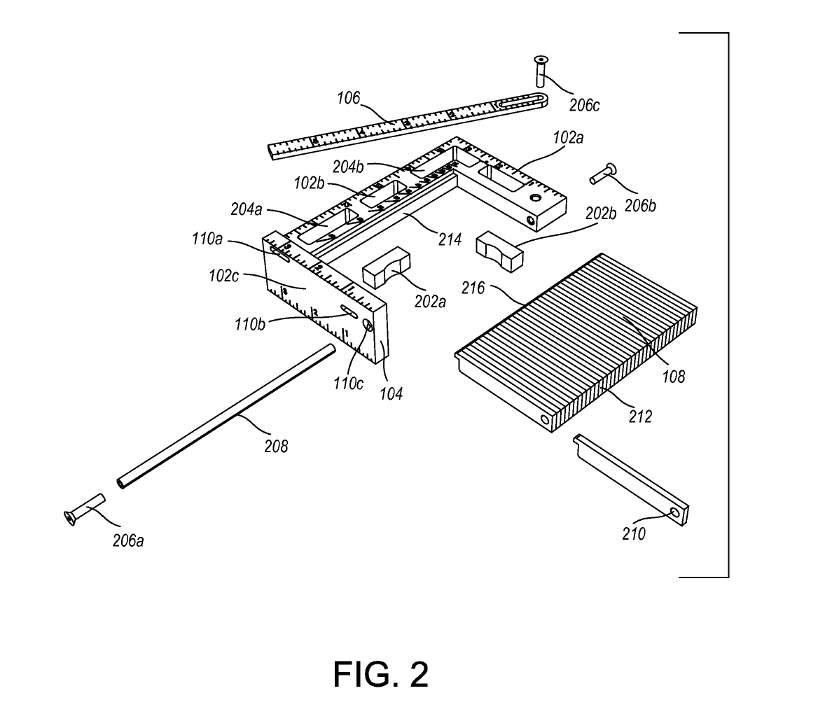

The solid body frame 102 includes three sides such as first side 102a, second side 102b and third side 102c. The second side 102b further includes a lip (not shown in FIG. 1). The lip is explained in detailed in conjunction with FIG. 2 of the technology described herein. The third side 102c of the solid body frame 102 further includes one or more recesses 110 such 110a, 110b and 110c.

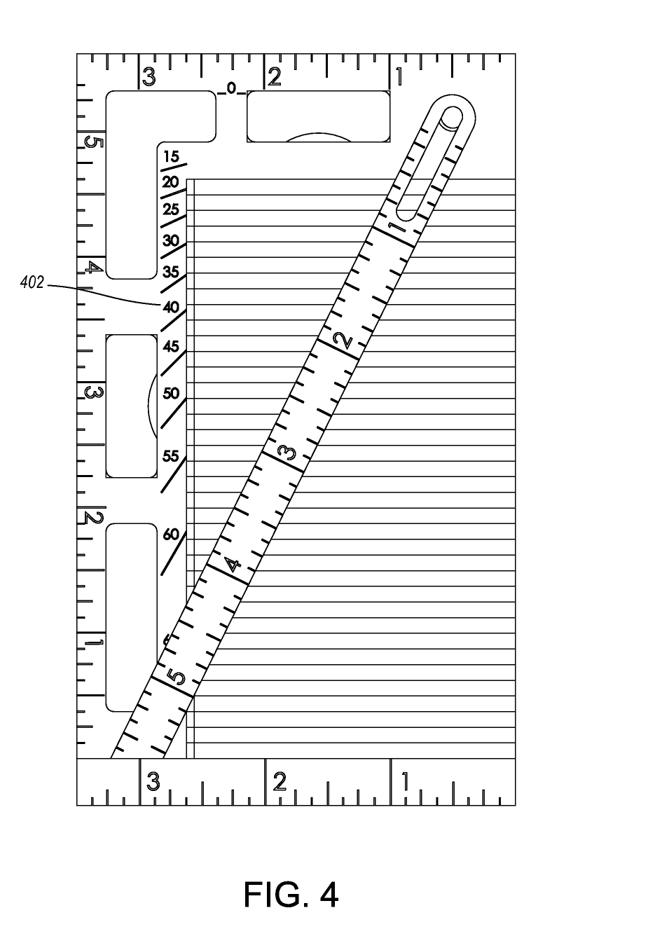

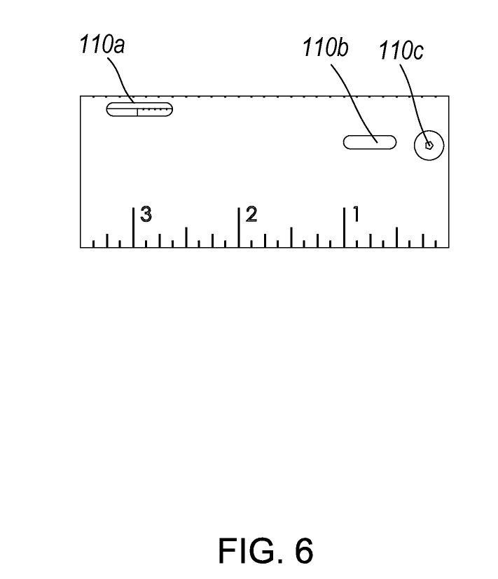

The solid body frame base 104 is attached to the third side of the solid body frame 102c. However it may be noted that one skilled in the art may affix the solid body frame base 104 onto the third side of the solid body frame 102c, without deviating from the scope of the invention. The solid body frame 102 and solid body frame base 104 are explained in detail in conjunction with FIG. 4 and FIG. 6, respectively of the technology described herein.

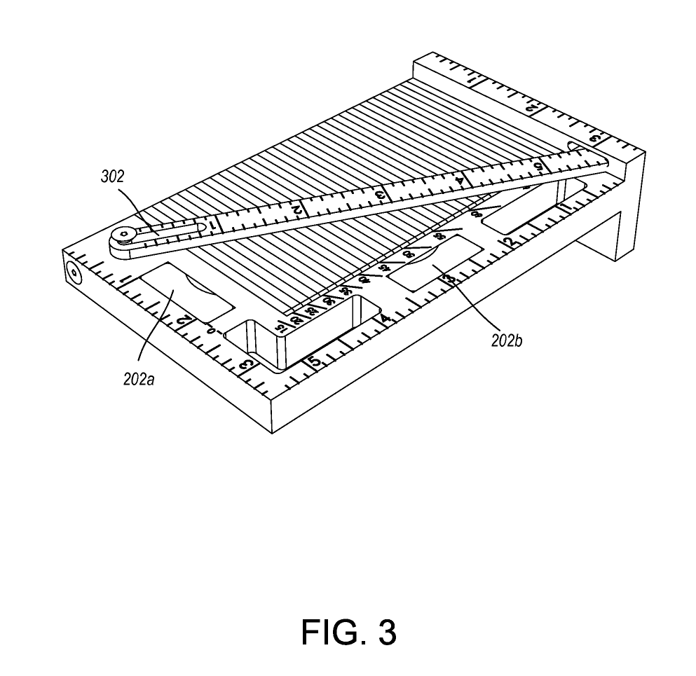

The angle gauging arm 106 is pivotally attached at the first side of the solid body frame 102a. The angle gauging arm 106 is explained in detail in conjunction with FIG. 3 of the technology described herein. The solid body frame 102, solid body frame base 104 and angle gauging arm 106 have one or more predetermined markings. The predetermined markings are explained in detail in conjunction with FIG. 3 of the technology described herein.

The speed fingers 108 rests on the lip (not shown in FIG. 1). The speed fingers 108 are explained in detail in conjunction with FIG. 1 of the present of the invention. The base rod (not shown in FIG. 1) passes through the one or more hinges 110c and hinge to the one or more spacing fingers 108. The base rod (not shown in FIG. 1) is explained in detail in conjunction with FIG. 2 of the technology described herein.

FIG. 2 illustrates an exploded view of the adjustable carpenter square 100. The adjustable carpenter square 100 further includes a one or more leveling bubble 202, such as 202a and 202b inserted in the first side 102a and the second side 102b of the solid base frame 102. The leveling bubble 202 to assure a level state of the angle gauging arm 106 and the solid body frame 102 and solid body frame base 104 with the work product.

The adjustable carpenter square 100 further includes a one or more hands free leveling unit 204 such as 204a and 204b. The hands free leveling unit 204 is created as an opening in the first side 102a and second side 102b of the solid body frame 102. In another embodiment of the technology described herein, the hands free leveling unit 204 may allow the solid base frame 102 to suspend when required by the carpenter/user.

The adjustable carpenter square 100 further includes a one or more attachment means 206 such as 206a, 206b and 206c. The base rod 208 passes through the recess 110c and attaches the one or more spacing fingers 108 with the first side 102a of solid body frame 102 and solid body frame base 104 with the help of attachment means 206a and 206b. Each of the spacing fingers 108 is hinged from the base rod 208.

The base rod 208 runs the full length of the solid body frame 102 from the slotted end 210 of each spring finger 108. The angle gauging arm 106 is attached to the first side 102a of the solid body frame 102 by the attachment mean 206c. The base rod 208 further provides pivotal movement of the one or more spacing fingers 108 at a first end 212. The second side 102b of the solid body frame 102 includes the lip 214. The one or more spacing fingers 108 rests on the lip 214 at second end 216. The lip 210 allows the angle measurement of rough or rounded edge of the work product.

FIG. 3 illustrates another perspective view of the adjustable carpenter square 100 of the technology described herein. The angle gauging arm 106 is stored in a triangular manner of the front of the square. The angle gauging arm 106 measure various angles on the work product. The angle gauging arm 106 includes an opening 302. The angle gauging arm 106 is pivotally detachable to the first side 102a by the attachment mean 206b at the opening 302 and the opposite end of the angle gauging arm 106 slides into the recess 110a.

The attachment mean 206b may be loosened and the angle gauging arm 106 is removed from the opening 302 and thus the carpenter/user may freely swing the angle gauging arm 106 as required for the measurement of any angle. In a preferred embodiment of the technology described herein, the leveling bubble 202a and 202b may be inserted in the first side 102a and second side 102b, as shown in FIG. 3 of the technology described herein.

FIG. 4 illustrates a top view of the adjustable carpenter square 100 of the technology described herein. In a preferred embodiment of the technology described herein, the solid body frame 102 is 3½ inches by 6 inches. The first side 102a, the second side 102b and the third side 102c are marked in ⅛ inch increments. The numbers are shown in one inch increments.

The solid body frame base 104 may be ⅜ inches thick. The solid body frame base 104 may protrudes ¾ inches on the front side and ¼ inch on the opposite side. The lip 214 is ¾ inch in width. However, a small width such as ¼ inch may also be used for lip 214 for best working with work products which have a smaller dimensions or depth.

The predetermined markings further include degree markings 402. The degree markings 402 are located beneath the one or more leveling bubble 202 along the second side 102b of the solid body frame 102. The degree markings 402 permit the carpenter/user to determine the angle of the work product intersections. Further, the degree markings 402 permit the carpenter/user to place a mark on materials when required. The angle gauging arm 106 is 6 inches in length and is marked in ⅛ inch increment and further is numbered in 1 inch increment.

In a preferred embodiment of the technology described herein, the one or more spacing fingers 108 include 37 fingers and each spacing finger 108 is ⅛ inch wide and 2⅛ inch in length. The width of each of the one or more speed fingers 108 is 3% inches. It will be known to any person skilled in the art that other similar markings for measurement and angles may be used without deviating from the scope of the technology described herein.

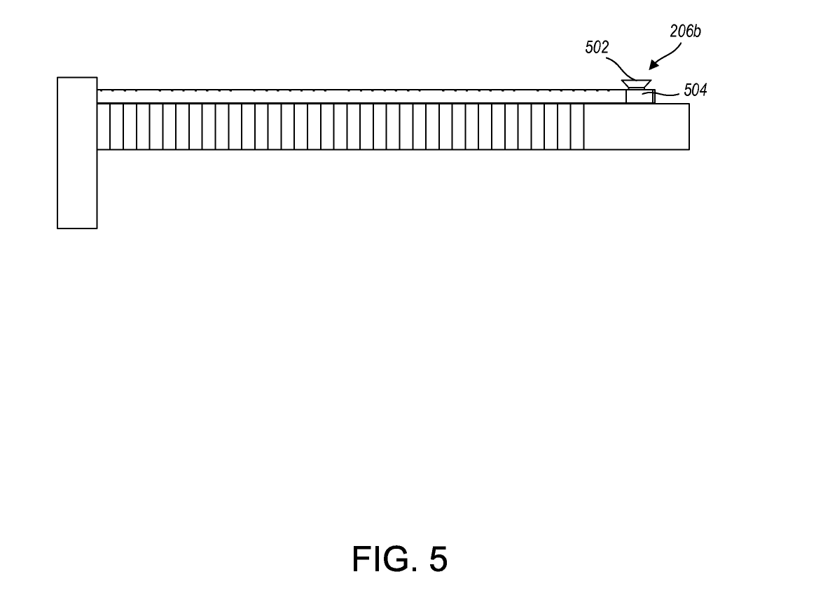

FIG. 5 illustrates a side view of the adjustable carpenter square 100 of the technology described herein. The angle gauging arm 106 is attached to the first side 102a with the attachment mean 206b. Example of the one or more attachment means 206 includes but not limited to screw, nuts and bolts. In a preferred embodiment of the technology described herein as shown in FIG. 5, the attachment means 206b includes a screw 502 and a bolt 504 to attach angle gauging arm 106 with the first side 102a.

FIG. 6 illustrates a front view of the adjustable carpenter square 100 of the technology described herein. The size and shape of one or more recesses 110 depends on the shape and size of the angle gauging arm 106, the base rod 208 and the one or more spring fingers 108.

The adjustable carpenter square offers various advantages. The adjustable carpenter square is capable of performing multi-purpose functions such as squaring, gauging, gapping, and angle instrument. Further, the adjustable carpenter square is compact in size and thus may be carried in a pocket of the carpenter/user.

The foregoing discussion discloses and describes merely exemplary embodiments of the technology described herein. One skilled in the art will readily recognize from such discussion and from the accompanying drawings that various changes, modifications and variations can be made therein without departing from the spirit and scope of the invention.

1. An adjustable carpenter square for measuring and marking a work product, the adjustable carpenter square comprising:
a solid body frame having a first side, a second and a third side, the second side having a lip, the third side having one or more recesses;
a solid body frame base attached to the third side of the solid body frame, the solid body frame base allows to obtain measurements of the work product from various positions;
an angle gauging arm pivotally detachable to the first side of the solid body frame, the angle gauging arm to measure various angles on the work product;
a one or more predetermined markings on the solid body frame, the solid body frame base and the angle gauging arm;
one or more spacing fingers having a slotted first end and a second end to rest on the lip, the one more spacing fingers to gauge gaps between the work product; and
a base rod to pass through one of the one or more recesses and hinged to the one or more spacing fingers, the base rod to provide pivotal movement of the one or more spacing fingers.

2. The adjustable carpenter square according to claim 1 further comprises a one or more leveling bubble inserted in the first and the second sides of the solid body frame, the leveling bubble to assure a level state of the angle gauging arm and the solid body frame base with the work product.

3. The adjustable carpenter square according to claim 1 wherein the one or more spacing fingers comprises thirty-seven fingers, wherein each finger has a ⅛ inch width and a 2⅛ inch length.

4. The adjustable carpenter square according to claim 1 further comprises a one or more hands free leveling unit created as an opening in the first side and second side of the solid body frame, further said one or more attachment means to detachably attach the base rod with first side and the third side of the solid body frame.

5. The adjustable carpenter square according to claim 1 wherein the lip to measure angles of rough or rounded edge of the work product.

6. The adjustable carpenter square according to claim 1 wherein the predetermined markings are marked in increments of ⅛ inch.

7. The adjustable carpenter square according to claim 1 further comprises a one or more attachment means to detachably attach the angle gauging arm with the first side of the solid body frame, further said one or more attachment means to detachably attach the base rod with first side and the third side of the solid body frame.

8. An adjustable carpenter square for measuring and marking a work product, the adjustable carpenter square comprising:
a solid body frame having a first side, a second and a third side, the second side having a lip, the third side having one or more recesses;
a solid body frame base affixed to the third side of the solid body frame, the solid body frame base allows to obtain measurements of the work product from various positions;
a angle gauging arm pivotally detachable to the first side of the solid body frame, the angle gauging arm to measure various angles on the work product;
a one or more predetermined markings on the solid body frame, the solid body frame base and the angle gauging arm;
one or more spacing fingers having a slotted first end and a second end to rest on the lip, the one more spacing fingers to gauge gaps between the work product;
a base rod to pass through one of the one or more recesses and hinged to the one or more spacing fingers, the base rod to provide pivotal movement of the one or more spacing fingers; and
a one or more leveling bubble inserted in the first and the second sides of the solid body frame, the leveling bubble to assure a level state of the angle gauging and the solid body frame base with the work product.

9. The adjustable carpenter square according to claim 8 wherein the one or more spacing fingers comprises thirty-seven fingers, wherein each finger has a ⅛ inch width and a 2⅝ inch length.

10. The adjustable carpenter square according to claim 8 further comprises a one or more hands free leveling unit created as an opening in the first and second side of the solid body frame.

11. The adjustable carpenter square according to claim 8 wherein the lip to measure angles of rough or rounded edge of the work product.

12. The adjustable carpenter square according to claim 8 wherein the predetermined markings are marked in increments of ⅛ inch.

13. The adjustable carpenter square according to claim 8 further comprises a one or more attachment means to detachably attach the angle gauging arm with the first side of the solid body frame, further said one or more attachment means to detachably attach the base rod with first side and the third side of the solid body frame.

14. An adjustable carpenter square for measuring and marking a work product, the adjustable carpenter square comprising:
a solid body frame having a first side, a second and a third side, the second side having a lip, the third side having a one or more recesses;
a solid body frame base connected to the third side of the solid body frame, the solid body frame base allows to obtain measurements of the work product from various positions;
a angle gauging arm pivotally detachable to the first side of the solid body frame, the angle gauging arm to measure various angles on the work product;
a one or more predetermined markings on the solid body frame, the solid body frame base and the angle gauging arm;
one or more spacing fingers having a slotted first end and a second end to rest on the lip, the one more spacing fingers to gauge gaps between the work product;
a base rod to pass through one of the one or more recesses and hinged to the one or more spacing fingers, the base rod to provide pivotal moment of the one or more spacing fingers;
a one or more leveling bubble inserted in the first and the second sides of the solid body frame, the leveling bubble to assure a level state of the angle gauging and the solid body frame base with the work product; and
a one or more hands free leveling unit created as an opening in the first side and the second side of the solid body frame.

15. The adjustable carpenter square according to claim 14 wherein the one or more spacing fingers comprises thirty-seven fingers, wherein each finger has a ⅛ inch width and a 2⅝ inch length.

16. The adjustable carpenter square according to claim 14 wherein the lip to measure angles of rough or rounded edge of the work product.

17. The adjustable carpenter square according to claim 14 wherein the predetermined markings are marked in increments of ⅛ inch.

18. The adjustable carpenter square according to claim 14 further comprises a one or more attachment means to detachably attach the angle gauging arm with the first side of the solid body frame, further said one or more attachment means to detachably attach the base rod with first side and the third side of the solid body frame.
